(19) United States
(12) Patent Application Publication
(10) Pub. No.: US 2025/0190824 A1
(43) Pub. Date: Jun. 12, 2025

(54) RAPID DATA ANNOTATION FOR MACHINE LEARNING

(71) Applicant: Aicadium Holdings Pte. Ltd., Singapore (SG)

(72) Inventors: Dimitry FISHER, San Diego, CA (US); Joshua JACOBSON, Ann Arbor, MI (US)

(21) Appl. No.: 18/970,288

(22) Filed: Dec. 5, 2024

Related U.S. Application Data
(60) Provisional application No. 63/607,040, filed on Dec. 6, 2023.

(51) Int. Cl. G06N 5/043

(52) U.S. Cl. CPC G06N 5/043

(57) ABSTRACT

Systems and Methods are described herein for rapid data annotation for ML. Aspects comprise a method for inferencing with an ensemble of agents (“EoAs”), comprising receiving data for processing by one or more agents of the EoAs; selecting a plurality of Bright pool agents from the EoAs; performing a first inference operation with each Bright pool agent of plurality of Bright pool agents based on the received data to generate a plurality of intermediate outputs; performing ground-truthing on one or more of an intermediate outputs and a final output to generate one or more labeled outputs; and storing the labeled outputs in a data repository.

### CROSS REFERENCE TO RELATED APPLICATIONS

This Application claims the benefit of and priority to U.S. Provisional Patent Application No. 63/607,040, filed on Dec. 6, 2023, the entire contents of which are hereby incorporated by reference.

### BACKGROUND

### Field

Aspects of the present disclosure relate to machine learning (“ML”), and in particular to systems and method for rapidly annotating data for ML, such as may be used for rapid deployment, upgrade, and fine tuning of ML agent ensembles.

### Description of Related Art

ML is an extraordinarily capable technique applicable to many technical domains. However, the timeline for implementing a new ML model to handle some commercially important task can be significant, often because a well-formed dataset with appropriate annotations (e.g., labels) must first be constructed before model training can commence. In some cases, this lag may mean foregoing ML as a tool altogether in favor of less sophisticated, but more readily deployable solutions. There is an extant need in the art for techniques for speeding up data annotation for purposes of ML.

### SUMMARY

Certain aspects provide a method for inferencing with an ensemble of agents which may include at least one of Bright pool agents and Dark pool agents, the method comprising: receiving data for processing by one or more agents of the ensemble of agents; selecting a plurality of Bright pool agents from the ensemble of agents; performing an inference operation with each of the Bright pool agents of the plurality of Bright pool agents based on the received data to generate a plurality of intermediate outputs; combining the intermediate outputs to generate a final output; performing ground-truthing on one or more of the intermediate outputs and the final output to generate one or more labeled outputs; and storing the labeled outputs in a data repository.

Other aspects provide processing systems configured to perform the aforementioned method as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned method as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of an architecture of an ensemble of agents (“EoAs”) system for rapid data annotation for ML.

FIG. 2 depicts an example of a training and deployment stage sequence of inference operations for rapid annotation for ML.

FIG. 3 depicts an example of an inference data processing pipeline using an EoAs for rapid data annotation for ML.

FIG. 4 depicts an example of a training data processing pipeline for an EoAs for rapid data annotation for ML.

FIG. 5 depicts an example of an EoAs system training and deployment to perform rapid data annotation for ML.

FIG. 6 depicts an example of a method performed by a processing system for inferencing with an EoAs.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for rapid data annotation for ML. In particular, apparatuses and methods described herein may be configured for rapid data annotation ML operationalization by means of an EoAs comprising, in some embodiments, an active (“Bright”) pool of agents and an evaluation (“Dark”) pool of agents, wherein each agent comprises one or more of the following: a Foundation Model, a human annotator, or an ML model. Both Foundation models and ML models are Artificial Neural Networks, or AI agents in general. A conventional ML model is usually pretrained on a narrow range of data and tasks, and retrained for the specific data and task at hand. A Foundation model, on the other hand, is pretrained or built on a large corpus of literature, language(s), and/or multimodal data, and encodes knowledge across a range of domains or tasks. Foundation Models are usually available for adaptation and refinement in subsequent usage and fine tuning, but do not require retraining.

Aspects described herein provide many benefits over the state of the art, including: (1) an ability to generate results as soon as the initial data becomes available; (1) an ability to implement life-long ML (also referred to as “life-long learning” or “L3”), where the deployed apparatus improves its performance continuously or periodically using new data provided to it; (3) an ability to implement federated learning (“FL”) in which multiple deployed instances of the apparatus share their improvements, e.g. achieved via L3; (4) an ability to augment various aspects of ML operationalization with generative artificial intelligence (“genAI”); (5) ability to automate the ML operationalization capabilities via a feedback loop; and (6) an ability to detect the effects of model drift (e.g. data drift, concept drift), and to mitigate them by means of the methods above, alone or alongside other (e.g. fine-tuning) methods.

A technical problem with ML is the insufficient quantity of the real-world data. In the traditional approach to industrial ML, for example, data from the new production line, equipment, process, or SKU, needs first to be collected in sufficient quantity and variety. Then, the collected data needs to be annotated by skilled personnel. Then, the annotated data need to be augmented, a technique to enhance the utility of the available data in order to more effectively train a model. Finally, the augmented and annotated data can be used to train ML models. This process often takes 3-12 months, during which no results of any value are available for the stakeholders.

One recent approach for reducing the time to first results is to use genAI to speed up data annotation and augmentation. However, this approach alone often leads to data biases and poor performance of the ML solutions. Aspects described herein provides an alternative, and technically superior, approach, in which results are made available to the stakeholders as a secondary output of the process of data annotations, and where the deployed solution improves its performance continuously and rapidly as more data is collected.

### Ensemble of Agents

Various benefits described herein are derived from the usage of an EoAs in embodiments. EoAs have been used to address common ML tasks, such as regression (prediction) and classification problems, where the target output is either a numeric or a categorical variable (a number, a word, or a token). However, EoAs are less often used for: object detection (where the target output is the bounding box around an object of a specific type or class); object segmentation (where the target output is a contour or a polygon around an object of a specific type or class); scene segmentation (where the target output is the foreground or background parts of the scene, or object groupings by proximity or relation); or change detection and anomaly detection in sequential images or videos. It is important to note that object detection, segmentation, change and anomaly detection are by far the most important use cases for industrial computer vision ML (CVML), and comprise a significant part of industrial ML use cases in general.

Any EoAs requires a pooling rule to work properly. The pooling rule (also known as “vote”, “combining rule”, etc.) specifies the method or algorithm of combining the output of each agent into one (e.g. most likely) output of the EoAs. The simplest, traditional way to construct the pooling rule is the majority vote for categorical data. For numerical data, a mean, median, or mode of the agent outputs is often used. More advanced approaches involve weighting the agent outputs (e.g. by relative reliability measure of the respective agents), or using a hierarchical approach where another agent assigns weights to the outputs of the individual agents (e.g. decides which agent's output to use in each particular case). In traditional approaches, the agents are artificial neural networks. Indeed, it has been shown that ensembles of weak classifiers can (and under a broad set of circumstances do) perform better than any single one of the agents (classifiers) in the ensemble. Ensembles of strong classifiers, likewise, may perform better than any single agent in the ensemble.

There are, however, two fundamental problems with the traditional approach. First, such approaches require that at least a few artificial neural networks perform significantly above chance (i.e. better than a random guess) on the pertinent data, and that is unlikely until the pertinent data is collected and annotated in adequate quantity and quality. This initial step of data cleaning, annotation, and augmentation in the traditional ML process takes significant time and effort.

Second, the traditional approach does not readily apply to the CVML use cases as far as the ensemble pooling step is concerned. Indeed, in CVML use cases (detection, segmentation, tracking, etc.), each agent returns a distinct bounding box(es) or contour(s), sometimes non-overlapping and sometimes overlapping multiple ones across agents. Furthermore, some (or each) bounding box(es) may be assigned to a different object class, tracking ID, and so on. Aspects described herein solve both of these technical problems.

As used herein, the words “to pool” and “to combine” are used interchangeably to describe the process of generating one consensus output from the outputs of a plurality of individual agents on the same data. For example, when datum D is provided as inputs to agents A1, A2, . . . , some (or all) of the agents will return their respective outputs O1, O2, . . . . The process of pooling or combining the outputs describes the generation of a consensus output O given the input D and the outputs O1, O2, . . . of individual agents in the EoAs. As explained above, each agent may be a human, a Foundation model, an ML model (e.g., an artificial neural network), and so on. Datum D may be a part of dataset S, which may be pre-existing or novel.

As used herein, the term module may refer to a distinct unit made up of software or hardware components, or a combination. A module may include a file, class, or other component within a larger software program that enables a specific functionality. Additionally, a module can refer to a pre-built unit or circuit that performs a specific task in a larger system, or a standardized unit that is part of a larger assembly. A module be any combination of the aforementioned.

In some aspects, the behavior of the EoAs and the way data is sent to various pool members for each inference is the responsibility of an Inference Ensemble Controller (“IEC”). The IEC may be a software or hardware module, or a combination. For example, the IEC may be an ML model. An inference as it relates to the field of ML is a prediction or conclusion drawn from the data. For example, an inference can be a type of data classification. The IEC may consist of an internal state register (“ISR”) as well as knowledge of the pool membership for each inference requested of the system. The ISR holds historical data about the performance of each agent in each pool, historical metadata about inferences made by each member of the pool, as well as operational settings that can be utilized in decision making per inference, such as target thresholds for inference time or confidence level, or number of agents to request output from. The IEC may utilize a variety of strategies when requesting inferences from various pool members that take advantage of data in the ISR (e.g. weighted or unweighted round robin, historical highest accuracy, historical least latency, consensus from multiple members, etc.), and can make control decisions pre-inference or post-inference. Over time, analysis of the data in the ISR coalesces into a clearer understanding of each member (e.g., agent) of each pool, and the IEC gains confidence in making load balancing decisions inclusive or exclusive of certain pool members. In some implementations, the IEC may also engage in bidirectional communication with the agents to impart additional metadata, performance metrics, or other relevant information (e.g. throughput, response latency, accuracy, etc.). This metadata can be utilized in order to direct each individual inference request to a subset of pool agents to perform the inference.

As previously noted, not every single inference request will be sent to every pool member for inference (e.g. to preserve performance related to inference throughput, slower agents may receive fewer inference requests than their faster counterparts). In some implementations of the controller strategy, the IEC may take performance or some other aspects of data in the ISR into consideration to selectively choose agents for inference requests based on the analysis of their past performance metrics or expected future performance. In some implementations, the IEC works over time to optimize pool membership or to optimize inference control strategies. For example, using the weighted round robin strategy, the IEC may increase the weights of higher performing (by any of the metrics mentioned above) agents, thereby delivering a higher percentage of inference requests to them in contrast to lower performing agents.

Beneficially, aspect described herein provide methods, architectures, and workflows to construct the EoAs, to monitor the EoAs and its outputs, as well as performance metrics of the individual agents and of the EoAs, to update the EoAs, to use its outputs (both individual and combined, as explained below) to ground-truth and expand the available data set(s), to train new or existing agents and improve its performance metrics, to prepare the EoAs for deployment, to deploy the EoAs, to enable active, life-long, continuous, and/or federated learning of the agents, and to improve the EoAs performance both in training and in deployment.

In some aspects, a human-in-the-loop and/or Foundation-model-in-the-loop may be used to provide the outputs O, O1, O2, . . . on the data D, and in the process of doing so, to add the annotated data [D,O] to the dataset S so that the agents can subsequently be trained on it. Further, the human-in-the-loop and/or Foundation-model-in-the-loop may be used to ground-truth the annotated data [D,O] prior to (or in the process of) its addition to the dataset S. The ground-truthing process involves a binary decision whether the output O is correct or incorrect for the input D, and if it is incorrect, then updating the output O to the correct value(s). The ground-truthed annotated data [D,O] is then added to the dataset S. The annotation process and the ground-truthing process may involve different human(s) or different Foundation models.

For example, the annotation process may involve the use of skilled annotators trained in the use of available commercial annotation platforms (e.g., Dataloop™, Labelbox™, V7™, AWS MTurk™, etc.) to generate labels, bounding boxes or contours, etc., that comprise the target outputs given the data. On the other hand, the ground-truthing process often involves the subject matter experts (SMEs) who are skilled in the analysis of the data, but not necessarily in the use of the labeling platforms. Therefore, in some implementations, the ground-truthing process does not involve the generation of annotations (outputs) O, O1, O2, . . . , but rather involves the binary classification of whether an output is correct or not given the data D. For example, the ground-truthing user interface may show the input (e.g., image) with the current annotation, and two choices: “yes, this annotation is correct” and “no, this annotation is incorrect”. Optionally, the SME may also provide a comment as to how or why the output is incorrect, and how to amend or improve it. Further, the SME may also provide a comment as to the importance or the quality of datum D, and whether such data should be excluded or weighted differently (higher or lower). Optionally, the SME may recommend amending or improving the data collection and preparation processes. For example, the ground-truthing user interface comment window or menu may allow comments like “label is correct but the bounding box is misplaced,” or “label should be XXX and not YYY,” or “this data point is bad and should be excluded,” or “this data point is of high importance, and the following actions are recommended: . . . ,” and/or options like “exclude this data point,” “augment this data point,” etc. Optionally, the SME may be able to drag, resize, add, remove, or redraw the bounding boxes or contours, or to change their labels. As explained below, this process is substantially similar for collected data and for data that is generated or modified using generative AI models.

### Additional Details of the IEC

Aspects described herein may use two agent pools, including a so-called “Bright” pool that contains the trusted agents, and a “Dark” pool that contains agents being tested. The outputs of the Bright pool (the combined (pooled) output of the Bright pool is denoted O, and the outputs of the individual agents in the Bright pool are denoted O1, O2, . . . ) may be used both to evaluate the performance of the Bright pool (both as a whole and of the individual agents) and to feed the annotated data [D, O] and/or [D, O1, O2, . . . ] to the ground-truthing process. In some implementations, this annotated data is also shared with the client and/or other third parties, for example to elicit feedback on the accuracy and utility thereof. This allows for much quicker development and operationalization of a ML-based solution compared to conventional, long lead time processes.

In some cases, human annotators may be augmented or replaced by Foundation models (e.g., Grounding DINO, RegionCLIP, etc.) and/or by pretrained ML models. In particular, it is a common practice to use ML models pretrained on publicly available datasets to perform initial annotation, and to use the human annotators to perform the final annotation. Similarly, in the ground-truthing process, human SMEs may be augmented or replaced by Foundation models (e.g., based on GPT4) that implement visual question-answering or similar multimodal functionality, with or without fine-tuning, prompt tuning, retrieval augmentation, and so on.

In the evaluation process, advanced scoring and explainability methodologies (e.g. Shapley additive explanations (SHAP)) may be employed to evaluate the performance of individual agents in the pool and of their overall contribution to the consensus output O. Performance metrics may include, for example, accuracy, precision, recall, mAP50, uncertainty, speed or latency of operation, resource consumption (e.g., electric power, GPU RAM), and so on. In some implementations, the least-contributing or worst-performing agents are periodically removed from the Bright pool. Likewise, the best-performing agents of the Dark pool are periodically added to the Bright pool. This affords an additional benefit of quickly improving the Bright pool performance, while training or instantiating new agents in the background. Agents that have been trained in the background are added to the Dark pool for a period of evaluation. Such training may include transfer learning or additional training to the copies of existing agents. The overall goal is to bring the individual ML agents to near-human or super-human performance, so that the Bright pool deployed as a part of the ML solution may no longer need human agents. Indeed, the ML agents scale gracefully to multiple deployed instances, and offer latencies in sub-second time range. By contrast, human agents scale poorly, and have latencies of minutes, hours, or days. Also of note, in some cases, the egress of data is undesirable, and in those cases, the ML agents and the full solution may be deployed in a private cloud, on premises, and/or in hardware, without human agents in the final ensemble. In some implementations, the Dark pool agents are also deployed to the client's cloud, premises, and/or hardware; for example for the purpose of active learning, lifelong learning (L3), and/or federated learning; as explained below.

In some implementations, the IEC is also trainable, and/or updated as the agent composition of the Bright pool is updated.

In some implementations, the performance metrics of the Bright pool (combined as well as individual agents) may be monitored, tracked, and evaluated over time to detect model drift (data drift, concept drift) or change in the data statistics. Statistical tests as used for change detection, stationarity and homoscedasticity testing, etc., may be employed for that purpose. Such a change or drift, when detected, should be noted as it may produce a deterioration in accuracy and other performance metrics. The ability of the agents to generalize gracefully to out-of-distribution data may be considered when constructing or updating the Bright pool and the IEC. In some implementations, the agents that perform better on the new and/or out-of-distribution data may be assigned higher weights by the IEC or preferentially retained in the Bright pool.

### Active Learning, Continuous Learning, and Life-Long Learning

Active ML, continuous ML, and life-long ML are three related but substantially distinct advanced methodologies in the ML domain aimed at improving the performance of ML agents (e.g., artificial neural networks), especially in real-life applications. In contrast to academic benchmark datasets that are fixed, in real life implementations (both during training and deployment) the ML agents encounter previously unseen data that they need to be trained on.

In active ML, which utilizes active learning, the ML agent proactively selects the subset of data to be labeled (annotated) next from the unlabeled data set. In aspects described herein, this is accomplished as a part of the ground-truthing process of the workflow, in the following fashion. For each data point, a Bright-pool combiner may quantify both the confidence of agents' output (note that in some cases ML agents report confidence scores explicitly) and the amount of disagreement between agents. These metrics are then used to flag inputs (data points) on which the Bright pool has the least confidence and/or the most disagreement. Such data points may be preferentially fed to the ground-truthing process (especially when the ground-truthing bandwidth or latency does not allow all outputs to undergo ground-truthing), followed by additional annotation if necessary. Also, such data may then be preferentially fed to the data augmentation and synthetic data generation process. This method of preferential ground-truthing of data is of particular benefit in deployment and continuous operation. Indeed, in those cases the volume of data is often large, and the required processing latency is short; therefore, most of the data is only used for inference, and only a minority of data undergoes ground-truthing or is added to the training dataset. Therefore, in deployment and continuous operation, it is beneficial to selectively ground-truth the more challenging data points. Even when data egress is not allowed in deployment, alerts may be generated for an SME to inspect the most challenging data points and then to pass the allowed information to a development team so that the right type of synthetic or publicly available data points may be generated or collected to address the challenging case(s). Such data may be used to facilitate life-long learning, as explained further below. In all instances, creation, deletion, updates, or modifications to data may be accomplished by manual or automated processes.

Continuous ML is a process in which an AI agent learns continuously from a stream of data, often in the deployment or pre-deployment stage. This is in contrast to learning only during training as in traditional methods. Note that the term “continuous machine learning” or CML may refer to two distinct meanings. The first meaning denotes the process described above. The second meaning denotes a set of the best practices for continuous integration/continuous delivery (CI/CD) of ML models, and the software automating or facilitating some of those practices (such as CML from iterative AI). Herein, the term CML is used to denote the first meaning.

In various aspects, there are three methods of CML: (1) continuous learning via ensemble updates; (2) continuous learning via agent updates; and (3) continuous learning that uses the federated-learning methodology described below. It is emphasized that these three methods are not mutually exclusive, and can be combined.

CML that uses ensemble updates does not require retraining of AI agents. Rather, it may include updating a Combiner module (as well as, optionally, the IEC) to rely more on the better performing agents or to rely less on the poorer performing agents of a Bright ensemble. In some implementations, the IEC sends more data points to the better performing agents and fewer data points to the worse performing agents. In some implementations, the Combiner module assigns higher weights, or more votes, to the better performing agents, and lower weights, or fewer votes, to the worse performing agents. This method of CML has a qualitative advantage of requiring very little additional compute, in contrast to retraining the FM or ML agents.

CML that uses agent updates performs additional fine-tuning or additional training of some or all of the agents. Care is taken to use minimal additional fine-tuning or training, to mitigate the risk of catastrophic forgetting (i.e., the drop in performance on previously learned data; see Stability-plasticity tradeoff, below), as well as to reduce the computational overhead of agent training. For FM agents, in most cases either prompt modification or parameter-efficient fine tuning may be utilized. For ML agents, likewise, efficient training methods (low-rank, early-stopping, etc.) may be applied.

CML that uses ensemble updates and agent updates, relies on the ground-truthing of data annotations, that is, on the feedback provided by the SME(s) (details of the SME feedback are described). Indeed, it is the ground-truthing process that provides information regarding the veracity of the Bright ensemble outputs (i.e., annotations). This information is required to improve the accuracy (precision, recall, mAP50, etc.) metrics of the Bright ensemble.

In some implementations of the present invention, a semi-supervised ML approach is used to facilitate CML. For example, when SME(s) are unable to ground-truth all the data annotated by the Bright ensemble, data points that bear sufficient similarity to previously ground-truthed data may not need to be ground-truthed, provided the annotations of the previously ground-truthed data were found correct in the ground-truthing process. An additional approach to mitigate the ground-truthing bandwidth or latency constraints is described above in relation to Active Learning. Active Learning and Semi-Supervised learning approaches described here are not mutually exclusive, and can be combined.

Life-long learning (“L3”) is a process of deployed instances of ML agents actively accommodating themselves to the new in-distribution or out-of-distribution data. The two key problems in L3 are catastrophic forgetting (or more generally stability-plasticity tradeoff), and lack of supervision.

Stability-plasticity tradeoff refers to the fine balance between forming new memories (learning new things) without overwriting, modifying, or corrupting the existing memories (forgetting what was previously learned). A human brain has this capacity: for example, learning a new motor skill does not significantly affect the existing (previously learned) ones. ML agents, however, often exhibit catastrophic forgetting in which learning on a new batch of data often causes a drastic decrease in performance on previous data batches, and learning a new task often causes failures on previously learned tasks.

Lack of supervision refers to the absence (unavailability) of the teaching signal for some or all items in the new batch of data. Indeed, the training data is usually annotated, so that supervised training of an ML agent can be executed. The data an ML agent encounters in deployment, however, is seldom if ever annotated. Consequently, the direct supervised training on the in-deployment data is seldom if ever possible.

In aspects described herein, both of the aforementioned technical problems are mitigated by using Foundation models. Generally, a Foundation Model is an artificial neural network (ANN) pre-trained on a large corpus of data, as explained above. In some cases, Foundation models are based on generative pre-trained transformer (GPT) architecture. While in some applications it is impractical to use Foundation models directly for inference due to their relatively long latency and high computational requirements, aspects described herein enable effective use of Foundation models both as a part of the inference ensemble and for annotating new data that ML agents can be subsequently trained on.

For example, when one or more of the Bright ensemble agents are Foundation models, the IEC will consider their relatively long response latency, and only send some of the input data to those agents. In some implementations, active learning methods may be used to select the data items to be sent to the Foundation model agents. For example, in some implementations the data items may be sent to the Foundation model agents when lower-latency ML agents show large disagreement or low confidence scores on those data items. This process may be either probabilistic (e.g., using finite-temperature Monte Carlo), or deterministic (e.g., using business-logic or threshold values or trained classifier for disagreement and confidence metrics). In some implementations the data items may be sent to the Foundation model agents when their similarity to previously learned data is sufficiently low. A similarity metric may be, for example, one of the following: angle or distance (norm) between current and previous data points in a certain embedding space; or sparseness of the data representation by a trained sparse encoder; or a reconstruction error of a pretrained autoencoder; and so on. In some implementations, a dedicated anomaly detection module or change detection module may be used for this purpose.

Use of Foundation models as agents, as described herein, creates many technical benefits. First, the Foundation models provide more reliable inference on the data points where it is needed most; without wasting computational resources unnecessarily. Second, the annotation provided by the Foundation model agent(s), processed by the combiner module as necessary, is forwarded (directly or via the model evaluation module) to the ground-truthing module, including the inference metadata flags indicating the Foundation model(s) contributions for the respective data points. When only a fraction of data is sent to the ground-truthing module, as would often be the case in deployment, the data items for which the Foundation model(s) contributed to the inference (e.g., selected by the active learning algorithm, above) may be sent to the Ground Truthing module preferentially. Ground-truthed data points are then added to the dataset, as explained previously. Indeed, those data points are more likely to be novel or underrepresented in the dataset so far. Third, the preferential ground-truthing of the data points for which the Foundation model(s) contributed to the inference (e.g., selected by the active learning algorithm, above) allows for early detection of abnormal or suspect data by the human SME involved in the ground-truthing process.

Foundation models can also be used to augment or replace the SMEs in the ground-truthing process. To wit, a Foundation Model may indicate in its output whether the data (e.g. image) annotations produced by the Bright ensemble are accurate or inaccurate, correct or incorrect. Query prompts, examples, retrieval augmentation, fine-tuning, and related methods are well-suited for efficiently improving the Foundation Model performance on such a task. In some implementations, a human SME may provide ground-truthing of annotations of some of the data (e.g., an initial data batch), and the Foundation Model may then use some or all of those examples to augment or replace the human SME in the ground-truthing task.

During the training stage, an ANN (e.g., Foundation Models and ML Models) may be augmented with one or more humans-in-the-loop (as ensemble agents and/or ground-truthing SMEs), at least for some of the data. Reliance exclusively on artificial neural networks so that they learn from one-another may lead to suboptimal results.

### Federated Learning (FL)

Federated learning (FL) is a process in which an ML agent trains via multiple independent sessions, each using its own dataset. In many cases, this is implemented as multiple independent instances of the same ML agent training each on their respective data, and then sharing or pooling their parameter updates. FL may be used in CML.

In certain aspects described herein, training of the ML agents may include FL. That way, multiple instances of the implementation of the present invention may share their improvements and updates with each other, even when training data sharing across instances is not allowed or not practical. In many implementations, this may be implemented in one or both of the following methods.

The first method is based on ensemble update. For example, multiple instances of an EoAs (Bright pool and/or Dark pool, as explained above), each instance deployed independently of others (e.g., on a different production line or work site). Performance metrics of ML agents are tracked across implementation instances, and ML agents that perform better across instances may be assigned higher weights by the IEC or preferentially retained in the Bright pool. In some implementations, an ML agent may be present in some but not all ensemble instances. In such implementations, the ML agents that perform better across instances may be assigned or reassigned to more ensembles, and the ML agents that perform worse across instances may be assigned or reassigned to fewer ensembles.

The second method is based on individual agent updates. For a specific ML agent, the parameter updates generated in the plurality of instances may be combined (e.g., by averaging) to produce a new ML agent which is then added to a Dark pool or a plurality of Dark pools. As mentioned above, to facilitate FL, the Dark pool agents may also be deployed alongside the Bright pool agents, in a plurality of deployed instances (e.g., at multiple sites or production lines, for a plurality of clients). This way the performance metrics and the parameter updates can be shared across instances, to allow the performance improvement of the deployed instances, even when the training or evaluation data cannot be shared across the instances.

In some implementations, common annotation standards or formats, such as Pascal VOC or COCO JSON, may be used. Annotation data may be stored in the metadata repository along with other metadata pertaining to each corresponding datum or sample of a plurality of data in a training or inference set. Annotation data may be accessed along with the training or inference data or accessed on demand when required (for example by the model evaluation module). Annotation data is created or verified and may be modified as part of labeling or annotation activities, ground-truthing procedure, or other validation activities. Annotation data may be versioned along with a data set proper or may be versioned independently to provide additional granularity in training, testing, and overall optimization activities. In all instances, creation, deletion, updates, or modifications to annotation data may be accomplished by manual or automated processes.

In some implementations, public cloud providers have made available building blocks in the form of functionality, services, and modules which may be used to implement aspects of some of the modules described herein. In one such implementation, ML services are used to prototype and test ML agents. Labeling platforms are used to facilitate human agent annotation of data, and to implement components of active learning of the ML agents. Serverless functions and associated workflow orchestration tools may be used for data transformation or other incidental compute functionality. Block storage services may be used for object (data, metadata, etc.) storage. General purpose compute services may be used to structure and orchestrate underlying compute resources. Container registry services may be used for storing and deploying containerized compute instructions.

### Example Ensemble of Agents Architecture

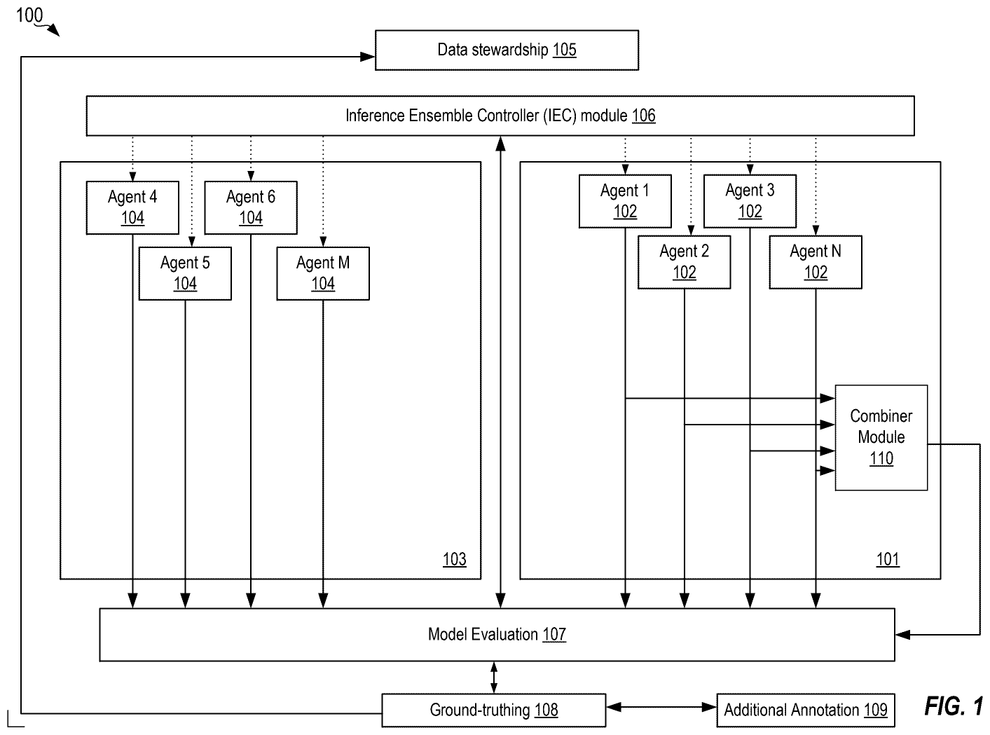

FIG. 1 depicts an example 100 of an architecture of an EoAs system for rapid data annotation for ML. As presented herein, dotted arrows depict transfer of non-annotated data, while solid arrows depict transfer of annotated data.

The example architecture 100 comprises a Bright pool 101 and a Dark pool 103. Bright pool 101 membership consists of a plurality of Bright pool agents 102 (e.g. b₁, b₂, . . . , b_{N}). As described above, generally, each Bright pool agent 102 in the Bright pool 101 may be one of: a trained model, a Foundation model, a human, or another novel inference agent.

Dark pool 103 membership in the example architecture 100 consists of a plurality of Dark pool agents 104 (e.g. d₁, d₂, . . . , d_{M} in this diagram). Each Dark pool agent 104 in the Dark pool 103 may be one of the same list as Bright pool 101. In some implementations, human agents are not included in the Dark pool 103. In some aspects, the Dark pool 103 serves as a test bed for new agents' performance so as to determine which of the Dark pool agents 104 should or should not be promoted to the Bright pool 101. An exception may be a “probation” or “evaluation period” for a human agent during training, when their performance is questionable. The human agent may be included in the Bright pool 101 for subsequent training passes if their performance meets certain performance levels or criteria.

A data stewardship module 105 sends data and corresponding metadata to an IEC 106, and concurrently, ground-truth annotations to a model evaluation module 107, which may correspond to the data sent to the IEC 106, if available. The data stewardship module 105 can store data, facilitate data transfers between different modules of the example architecture 100, and serve as a centralized data management and storage repository for the example architecture 100. The IEC 106 determines which agents 102, 104 in each pool 101, 103 will receive data for processing. In some aspects, previously ground-truthed data is not sent to certain types of agents 102, 104, e.g., human agents, or has a lower likelihood to be sent to these types of agents. In some aspects, there is a need to further label data that has already been ground-truthed. Previously ground-truthed data is sent to the agents 102, 104, to assess their performance (as well as, optionally, the performance of a combiner module 110 in relation to the Bright pool agents 102). When human agent performance metrics need to be assessed, previously ground-truthed data may be sent to the human agents, as well.

Upon receiving data from the IEC 106, the agents 102, 104 perform inference and return their respective results, e.g., produce labels for the data. In some cases, not all agents 102, 104 will return results due to timeout or failure to infer. In some aspects, Dark pool agents 104 return results directly to the model evaluation module 107, while Bright pool agents 102 return results to both the combiner module 110 and directly to the model evaluation module 107. The combiner module 110 combines (pools) the outputs of the Bright pool agents 102 as described above and sends the combined output to the model evaluation module 107.

The model evaluation module 107 analyzes performance metrics for each agent 102, 104 that received data from the IEC 106, based on their respective inference as well as the accuracy of any agent's inference against a ground-truth, if a ground-truth is available. If a ground-truth is not available, the model evaluation module 107 can trigger ground-truthing on the received outputs, e.g., the combined outputs of the Bright pool agents 102 from the combiner module 110, e.g., using a ground-truthing module 108.

In some cases, ground-truthing by the ground-truthing module 108 can occur in two steps: first establishing veracity of the combiner-generated annotation, followed by additional annotation 109 that corrects, amends, approves, or otherwise augments the combiner-generated annotation, where applicable. When performance latency is intended to be minimized, not all outputs undergo ground-truthing, or the rate of ground-truthing is set to reduce latency.

The ground-truthing module 108 then updates the data stewardship module 105 with ground-truth annotations for the corresponding data sending this now ground-truthed data to the data stewardship module 105.

### Example Operational Flow

As is a standard operating practice in ML, a solution is first trained, then tested on holdout data, then deployed. Aspects described herein beneficially enable (1) the training stage to be much shorter than in the traditional approaches, and (2) the results to be available during training, and not only in deployment as in standard approaches.

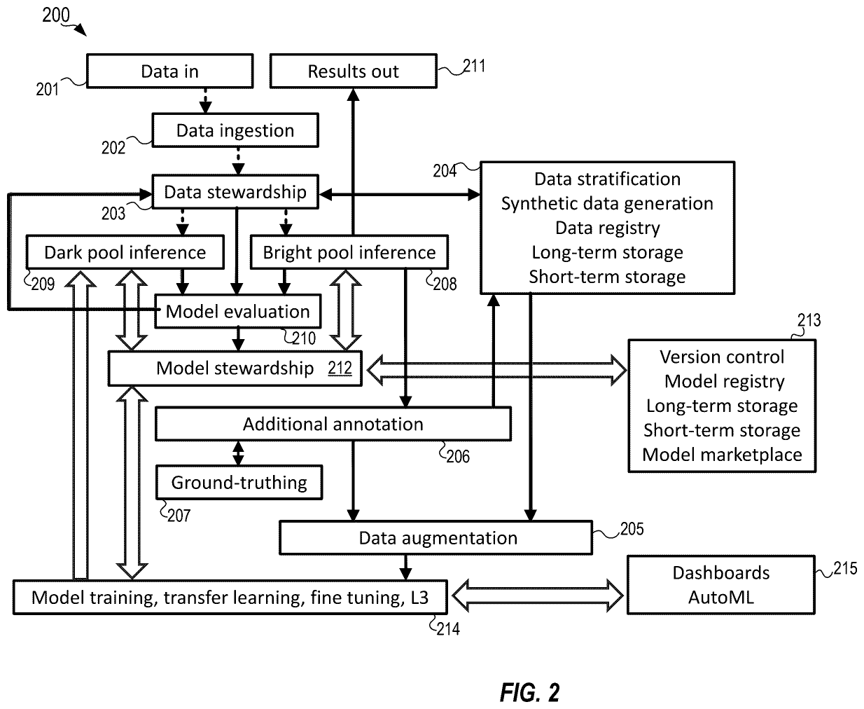

One example of a training and deployment stage sequence of inference operations is described with respect to example 200 of FIG. 2.

As presented in this figure, annotated data is depicted with solid line arrows, while unannotated data is depicted by using dashed/dotted line arrows. Thicker arrows depict activity, outputs or updates of agents. In some aspects, the example 200 is related to an EoAs implementation that can be used in association with or by an L3 model. The example 200 can be triggered by the L3 model encountering new relevant data at block 201.

A first pass (e.g., regarding a first portion of data on a new project or task) may begin at block 202 with ingesting the data. At this stage, data files are received and their schema, format, encryption, integrity, role-based access policy, etc. are determined. In many cases, this would be the first portion or batch of data, and more data may become available later during both training and deployment stages.

In some aspects, at block 203 the ingested data is managed by a data stewardship module, which may correspond to the data stewardship module 105 of FIG. 1. At block 203 the data stewardship module stores the ingested data in quick-access cloud storage, or any other repository accessible to the IEC. Data stewardship at 203 can include various data stewardship actions including adding security measures or encryption to the data, protecting sensitive information, eliminating data, adding or stripping metadata and the like.

Next, at block 204 the data is stratified. Data stratification refers to techniques of splitting data into different data sets, such as a training data set and a testing dataset. Typically, data stratification tries to ensure that the data sets are balanced in the types of data they include. At this stage, the data statistics are determined, and data are split into training, validation, and, optionally, holdout datasets. In some aspects, data stratification is performed by the data stewardship module 105 of FIG. 1. As data annotations are not yet available at this stage, data stratification is carried out based on the data and metadata statistics alone, using standard or custom unsupervised-learning techniques such as dimensionality-reduction and clustering. The data, including the stratification results (e.g., training, validation, or holdout set assignment for some or all data points), are registered in a data registry. The data is also be stored on a short-term or long-term basis onsite, e.g., on a local enterprise database, or at an offsite location, e.g., an external cloud storage or a distributed repository. In some cases, no holdout dataset will be split off at this stage; rather, some of the data that will be ingested in future would serve as a holdout dataset. In some implementations, data is ranked (e.g. to enable Active Learning), either at block 204 on in a future step.

Next, optionally at block 205, the ingested data is combined with other available data (if applicable). At this stage, publicly- or commercially-available data, e.g., additional annotations, of a similar kind are added at block 206 to the data registry, e.g., the data registry from block 204. In some cases, this available data (additional annotations) are partially or completely pre-annotated. Note that the annotation rules and guidelines should be finalized to meet the requirements of ML tasks set. Once the annotation rules and guidelines are finalized, the human agents (“annotators”) in the potential agent pool are informed of the data and annotation guidelines, e.g., by the IEC module, in order that they return desired outputs (“annotations”) to directly add annotations to or augment the data at block 205, or by enhancing the additional annotations used to augment the data at block 205, e.g., correct/improve the additional annotations from block 206. In some aspects, a Foundation model agent in the potential agent pools, receives prompts or queries from the IEC module to enable it to return the desired outputs (“annotations”), e.g., to perform the data augmentation at block 205.

In some cases, the input (each data point from the ingested data from the block 202) would be an image or a sequence of images (e.g., video) or additional data or metadata (e.g., sound, camera position and settings, date, time, location, lighting, text, etc.). In many cases, the output (each annotation for a data point) would be a file or an entry in a file in a predetermined format, such as JSON for example. The output will be returned by some or all agents that receive the data point via the IEC module, as explained above.

Note that if the holdout dataset is split off at this (“first pass”) stage, it may also be processed (annotated) by a human agent or by a plurality of the human agents, e.g., to be added to or augment data at 205, and subsequently ground-truthed at block 207.

Next, agents are selected or retrieved for a Bright pool and, optionally, a Dark pool. The Bright pool and the Dark pool may correspond to the Bright pool 101 and the Dark pool 103 of FIG. 1, respectively. At this stage, the plurality of agents (e.g., any or all of the human agents, Foundation models, pretrained ML models (e.g., ANNs), and so on) are selected and assigned to either the Bright pool or the Dark pool, e.g., by the IEC module. The IEC module sends each of the available training data points to some or all of the agents, as explained above. Note that, in some implementations, the Dark pool may contain no agents (be empty) on the first pass, and only have agents assigned to it on subsequent passes (e.g., after some agents have been trained on the available data).

Next, inferences and evaluations are performed. For example, inferences at blocks 208, and at 209 on the data is performed by each Bright pool agent and Dark pool agent, respectively. Then at block 208 Bright pool agent outputs are combined, e.g., by the combiner module 110 of FIG. 1. Note that while processing in the first pass, many or all of the data points may not have been annotated, and the training data points may not be ground-truthed. Therefore, during the first pass, the performance accuracy is not determined or otherwise ignored. On the other hand, some metrics (e.g., response latency) can be determined already on the first pass.

Next, each agent's performance metrics are evaluated and recorded at block 210. In some cases, ground-truthing is performed, e.g., similar to ground-truthing at block 207, on some or all of the agent outputs or combined outputs, or as part of the evaluation at block 210. Further, data with ground-truth annotations is added to the data registry, for future use, e.g., subsequent passes.

Next, the combined outputs (after ground-truthing, if applicable) of the Bright pool agents are reported at 211, e.g., to a data scientist. Some or all of the annotated data available up to this point may then be used to train new agents, or to provide additional training to the existing agents of the Bright pool.

Next, at block 212, model stewardship information is updated, e.g. to include the performance metrics of the existing agents and to register the newly trained agents. The newly trained agents may be limited to Bright pool agents that meet specific performance metrics. In many implementations, the model stewardship information would include the details of the training and testing data sets for each model. Optionally, at block 213 experimentation records or registry would be stored, e.g. to record which model architectures, parameter and hyper-parameter values, prompts, etc. produce better or worse performance. Updating the model stewardship information may also cause updates to an ML model at block 214, e.g., an L3 model.

Next at block 214, the EoAs is updated based on the model stewardship that occurred at block 212. New, newly trained, or updated agents may be added to the Dark pool at block 214 based on updated model training data and results recorded/registered at block 212. Such agents should not be added to the Bright pool, as their performance metrics must first be determined using data that was not used in their training and initial testing. This is done on the next pass (or plurality of passes) where new or updated agents are added to the Bright pool from the Dark pool, e.g., by the IEC module at block 212, where a Dark pool agent is registered as a Bright pool agent if the Dark pool agent meets performance metrics.

After the first pass, aforementioned aspects may be repeated iteratively until some termination condition applies. A termination condition may include a certain threshold number of agents added to the Bright pool, or a certain quantity of annotated data being generated, or a certain number of annotated data meeting an acceptable threshold quantity.

For example, on a subsequent pass, new or additional data is ingested at the block 202 if available. The data should be compatible with the data ingested previously (e.g., on the first pass or previous passes).

The new or additional data is optionally be stratified and split at block 204. The new data, (including the stratification results, if applicable) is be registered in the data registry, e.g., at block 204.

Next, the new or additional data can be combined with other available data, which can include data ingested on the previous passes, e.g., at the block 202 (minus the holdout dataset, if applicable) and the publicly- or commercially-available data of a similar kind, as it becomes available, e.g., at block 206. In some implementations, new data will be arriving during training, e.g., from the Bright pool inference at 208, so that on some or all of the passes the new data will be becoming available. In other implementations, all of the training data would become available at once, and different passes will use different selections (subsets) of the data. Such subsets are chosen either at random (with or without repetition, as appropriate), or using a selection algorithm that takes the data stratification results into account. In some implementations, selection of the data subsets is influenced by the agents' previous performance on same or similar data points. For example, data points that the agents gave dissimilar, incorrect, or low-confidence results on can be reused on the subsequent passes of the algorithm.

Next, inference and evaluation is performed by the Bright pool and Dark pool at blocks 209 and 210, respectively. As above, the outputs of the Bright pool agents can be combined. Further, each agent's performance metrics is evaluated and recorded. In some cases, accuracy metrics (precision, recall, mAP50, etc., as applicable) are evaluated on the data points that have been ground-truthed so far (that is, that have the ground-truth annotations against which the accuracy metrics of agents can be evaluated). Note: In some cases, when ground-truth annotations are too time or effort consuming to obtain for many data points, some combined outputs can be used as an alternative.

Next, ground-truthing may be performed, e.g., at block 207, on some or all of the agent's outputs and/or on combined outputs that have not yet been ground-truthed.

Next, the data with ground-truth annotations and/or combined outputs is added to the data registry for future use e.g., at block 204.

Next, combined outputs (after ground-truthing, if applicable) are reported e.g., at block 211 to a data scientist or other user(s).

Note that various steps can be taken if the Bright pool (excluding the human agents) does not perform up to the required KPIs. For example, some or all of the annotated data available up to this point may be used to train new agents, or to provide additional training to the existing agents.

Next, the model stewardship information is updated at block 212 as above.

Next, new or updated agents may be added to the Dark pool, and the Bright pool membership is updated, if necessary. For example, when a Dark pool agent (or plurality of agents) perform sufficiently well, they may be moved to the Bright pool. Likewise, when a Bright pool agent (or plurality of agents) perform poorly (e.g., worse than the best Dark-pool agent), those poorly performing agents may be removed from the Bright pool.

Next, the IEC module and the combiner module is updated, if necessary. The IEC module update would usually be warranted, and in some cases triggered by an addition or removal of an agent to the Bright pool or Dark pool. In some implementations, the combiner module update is warranted, and in some cases triggered by an addition or removal of an agent to a Bright pool (e.g., when different agents are assigned different weights or different number of votes in the combiner module, when some agents perform consistently better than others). Previously evaluated performance metrics (latency, accuracy, etc.) can be utilized for this purpose.

If, during iterations of the aforementioned process, the Bright pool (excluding the human agents) performs up to the required KPI, then the Bright pool performance may be subsequently evaluated on the holdout dataset. If the Bright pool (excluding the human agents) does not perform up to the required KPIs on the holdout dataset, the iterative process resumes and in some cases the holdout dataset is updated.

In some aspects, Automated Machine learning (autoML) is used at block 215 to automate the ML learning process.

### Example Aspects of a Rapid Data Annotation System for ML

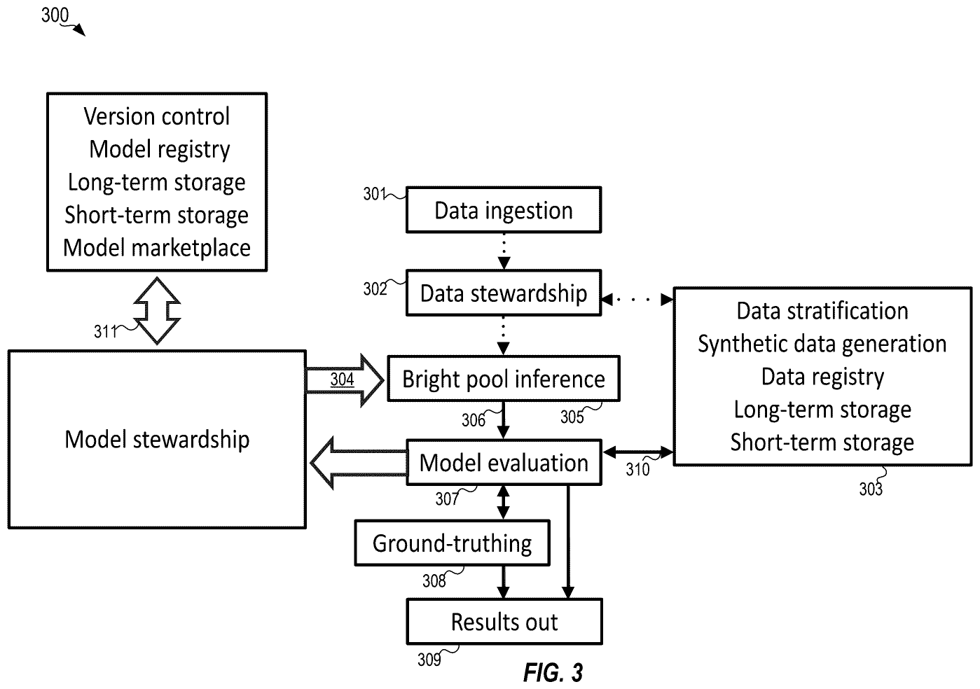

FIG. 3 depicts an example 300 of an inference data processing pipeline using an EoAs for rapid data annotation for ML. As presented in this figure, annotated data is depicted with solid line arrows, while unannotated data is depicted by using dotted/dashed line arrows. Thicker arrows depict activity or transfer of agents of the EoAs.

The example 300 is an example of a deployment of an EoAs system to generate usable outputs from inferences of agents of the EoAs. The usable outputs can include annotations of unlabeled data inputs. The example 300 may be part of a larger system that includes data management, training, as well as deployment of an EoAs, e.g., as part of the example 200 of FIG. 2 or it may be an independent EoAs inference system deployed in a modular setting.

As depicted in the example, in a first block 301, data is ingested. This data is not annotated. The first block 301 may correspond to the block 202 of FIG. 2

In a second block 302, the ingested data is stratified and split. The second block 302 may correspond to block 204 of FIG. 2.

In a third block 303, the ingested data is combined with available data (if applicable). The third block 303 correspond to block 205 of FIG. 2.

In a fourth block 304, agents for the Bright pool are selected. The Bright pool may correspond to the Bright pool 101 of FIG. 1.

In a fifth block 305, an inference on the data is performed by each selected Bright pool agent. Fifth block 305 may correspond to block 208 of FIG. 2.

In a sixth block 306, the outputs of all Bright pool agents are combined. The combining at the sixth block 306 may be performed by a combiner module that corresponds to the combiner module 110 of FIG. 1.

In a seventh block 307, the performance of each Bright pool agent is evaluated using available data labels (if any). The evaluating at 307 may correspond to the evaluation at block 210 of FIG. 2. These performance metrics may be recorded or otherwise stored in a data repository.

In an eighth block 308, ground-truthing is performed on some or all of the selected Bright pool agents' outputs and/or the combined outputs of the fifth and sixth blocks, above. Block 308 may correspond to block 207 of FIG. 2.

In a ninth block 309, the combined outputs are reported (after ground-truthing, if applicable). The ninth block 309 may correspond to block 211 of FIG. 2.

In a tenth block 310, ingested data with ground-truthing annotations (e.g., labels) and/or combined outputs (e.g., pseudo-labels) are added to the data registry for future use. Storing ground-truthed annotated data at the tenth block 310 may correspond to block 213 of FIG. 2.

In an eleventh block 311, one or more agents may be removed from the Bright pool. Likewise, one or more agents may be moved from the Dark pool into the Bright pool. This may correspond to updating model stewardship a block 212 of FIG. 2.

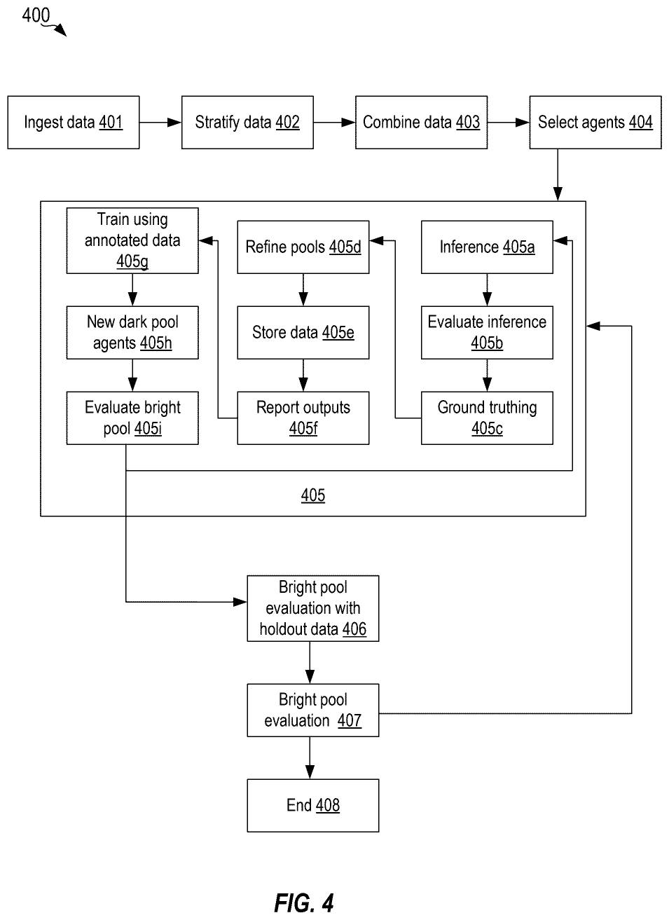

FIG. 4 depicts an example 400 of a training data processing pipeline for an EoAs for rapid data annotation for ML.

The example 400 is an example of an EoAs training system to generate high-performing agents capable of deployment as part of a high-performing EoAs system e.g., as in example 300 of FIG. 3. The outputs of the EoAs training system can include agents of a certain performance level capable of generating inferences for input data. The example 400 may be part of a larger system that includes data management, training, as well as deployment of an EoAs, e.g., as part of the example 200 of FIG. 2, or it may be an independent EoAs training system.

As depicted in the example 400, in a first block 401, data is ingested. This may correspond with the block 202 of FIG. 2.

In a second block 402, the ingested data is stratified and split into several data sets, e.g., training data, validation data, and holdout data. This may correspond with block 204 of FIG. 2.

In a third block 403, if additional data is available, the ingested data is combined with this additional data. Combining this data may correspond with block 205 of FIG. 2. The additional data may also be annotated data corresponding to the data at block 206 of FIG. 2.

In a fourth block 404, agents for the Bright pool and Dark pool are selected to be trained using the training data. The Bright pool agents may include the agents 102 from FIG. 1. The Dark pool agents may include the Dark pool agents 104 from FIG. 1.

In a fifth block 405, for each data batch, the following sub-blocks are performed.

In a first sub-block 405a of the fifth block 405, an inference is performed on the data by each Bright pool and Dark pool agent, and the Bright pool agents' outputs are combined. This may correspond with blocks 208 and 209 of FIG. 2.

In a second sub-block 405b of the fifth block 405, each agent's performance is evaluated using available data labels (if any), and performance metrics are recorded. This may correspond with block 210 of FIG. 2.

In a third sub-block 405c of the fifth block 405, ground-truthing is performed on some or all of the agent outputs and/or the combined outputs. This may correspond with block 207 of FIG. 2.

In a fourth sub-block 405d of the fifth block 405, the Dark pool and Bright-pool are refined (e.g., by adding new agents, removing agents, etc.) as needed. In some cases, the combining algorithm may also be refined (if applicable), e.g. by updating the weights or the number of votes of each agent. Such update may improve the accuracy of the combiner output. This may correspond with block 212 of FIG. 2.

In a fifth sub-block 405e of the fifth block 405, batch data is added with ground-truthing annotations and/or combined outputs to the data registry for future use. This may correspond with block 213 of FIG. 2.

In a sixth sub-block 405f of the fifth block 405, the combined outputs are reported (after ground-truthing, if applicable). This may correspond with block 211 of FIG. 2.

In a seventh sub-block 405g of the fifth block 405, some or all of the annotated data available up to this point is used to train new agents and/or to provide additional training to the existing agents, and the model stewardship information is thereafter updated. This may correspond with block 212 of FIG. 2.

In an eighth sub-block 405h of the fifth block 405, new or updated agents may be added to the Dark pool. This may correspond with block 212 of FIG. 2.

In a ninth sub-block 405i of the fifth block 405, the performance of the Bright pool is evaluated (e.g., against one or more criteria) and if it is determined that the performance is insufficient, the fifth block is repeated, and otherwise the process moves onto the sixth block. This may correspond with block 210 of FIG. 2.

In a sixth block 406, the Bright pool performance is evaluated on the holdout dataset using ground-truthing and/or available annotations. This may correspond with block 210 of FIG. 2.

In a seventh block 407, the Bright pool performance is evaluated (e.g., against one or more criteria) and if it is determined that the performance is insufficient, the fifth through seventh blocks are repeated, and otherwise the process completes at block 408. In some cases, the holdout dataset is updated. This may correspond with block 210 of FIG. 2.

### Example EoAs system for Rapid Annotation for ML

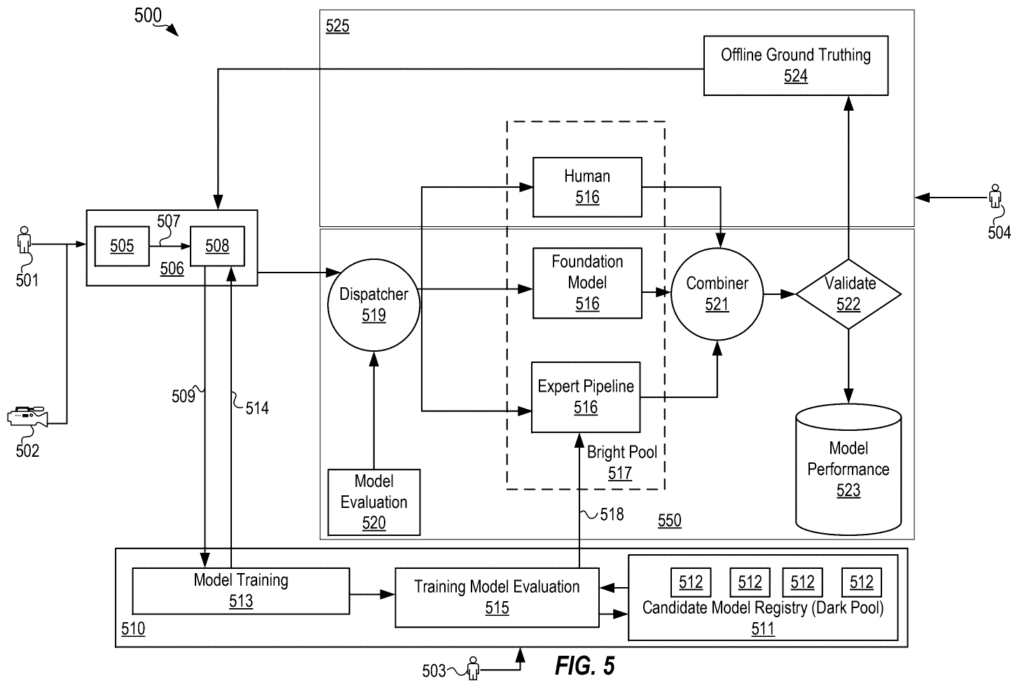

FIG. 5 depicts an example 500 of an EoAs system training and deployment to perform rapid data annotation for ML.

The example 500 includes a user 501, an image capture device 502, e.g., a camera, medical image device, scanner, smart devices, an endoscope and the like. The example 500 also includes a data scientist 503, and a subject matter expert (SME) 504.

In some aspects, at block 505 at least one of the user 501 or the image capture device 502 upload data, which may include one or more images, into the EoAs system via a data manager module 506. The data manager module 506 handles the collection, organization, storage, retrieval, and manipulation of data within the EoAs system. It efficiently manages large volumes of data, to ensure that the data is accessible, and secure. The data manager module 506 may correspond to the data stewardship module 105 of FIG. 1.

The data uploaded at 505 then enters a data ingestion pipeline 507 and the data ingestion pipeline 507 performs data ingestion processes including importing, transferring, processing, loading, or storing the uploaded data into a data storage 508. The data ingestion processes may correspond to the block 202 of FIG. 2. The data ingestion pipeline 507 can also identify labeled data 509 from the data that was ingested.

The EoAs system also includes a training system 510 for new agents. The data scientist 503 may set controls for the training system 510 that includes setting weights, biases, criteria, policies, as well as other settings for adding, training, testing, evaluating, managing, and adding or removing new Dark pool agents in the system, e.g., via specialized ML model training and evaluation software or libraries such as Metaflow™M. The training system 510 may comprise modules or processes corresponding to one or more segments of example 400 of FIG. 4.

New candidate agents are first added to a Dark pool candidate model registry 511 (simply referred to as Dark pool) as Dark pool agent(s) 512. The Dark pool 511 is a registry of Dark pool agent(s) 512 being considered for inclusion to a Bright pool 517. The Dark Pool 511 may correspond to the Dark pool 103 of FIG. 1.

The Dark pool agent(s) 512 can include a Foundation Model, a human annotator, or an ML model as described above. The Dark pool agent(s) 512 may be previous Bright pool agents, be generated automatically or manually (by the data scientist 503), e.g., from other agents, or imported from external sources. The Dark Pool agent(s) 512 may correspond to the Dark Pool agents 104 of FIG. 1.

The Dark pool agent(s) 512 are trained at a model training module 513, e.g., on labeled data 509 retrieved from the data storage 508. The model training module 513 may correspond with the fifth block 405 of FIG. 4 and may perform processes comprising any combination of its sub-blocks. The model training module 513 then produces outputs 514, e.g., data version history of training data that is stored in a registry or recorded in the data storage 508. In some aspects, the model training module 513 is also used to train the Bright pool agent(s) 516 already assigned to a Bright pool 517, e.g., when new types of data are encountered. The Bright pool agent(s) 516 may include a Foundation Model, a human annotator, or an ML model as described above.

The model training module 513 outputs from each trained agent are evaluated by a training model evaluation module 515, e.g., a training evaluation library such as Metaflow™. The training model evaluation module 515 determines results that the training system 510 automatically utilizes, or the data scientist 503 manually uses, to select the Dark pool agent(s) 512 to be removed from the Dark pool 511, e.g., discarded from the EoAs system based on poor training performance, and also determines the Dark pool agent(s) 512 that require additional training but whose performance levels do not warrant removal from the Dark pool 511 and therefore are maintained for additional training and evaluation. The training model evaluation module 515 results are also used to select which of the Dark pool agents will be added to the Bright pool 517 as Bright pool agent(s) 516 based on high performance in training. The Dark pool agent(s) 512 that are to be added to the Bright pool 517 are sent to the Bright pool 517 via a data pipeline connector 518, such as a Seldon Core+™ or KServe™ solution. In some aspects, the Dark Pool 511 push-triggers the data pipeline connector 518 to send the selected Dark pool agent(s) 512 to the Bright pool 517.

The data manager module 506 sends data in the data storage 508 to a dispatcher module 519 for unannotated data to be annotated. The dispatcher module is part of a larger controller 550 that performs inferencing and annotation of data. The controller 550 may be an IEC that corresponds to the IEC 106 of FIG. 1. The operations performed by the controller 550 may correspond to one or more of the operations performed in example 300 of FIG. 3.

Data is sent to the dispatcher module 519 to be annotated by the Bright pool agent(s) 516. The dispatcher module can schedule various inferencing tasks for the Bright pool agent(s) 516.

In some aspects, a model evaluation module 520 analyzes the data received by the dispatcher module 519 and provide it recommendations or instructions on which are the best suited models to annotate the data, e.g., a priority ranking of models in relation to each data set. The dispatcher module 519 then performs load balancing and resource management, and selects Bright pool agent(s) 516 from the Bright pool 517 and performs appropriate data routing to one or more of the selected Bright pool agent(s) 516. For example, the dispatcher module 519 selects Bright pool agent(s) 516 from the Bright pool 517 and assigns unannotated data to one or more of the selected Bright pool agent(s) 516 to be annotated based on the recommendations of the model evaluation module 520. In some aspects, some of the Bright pool agent(s) 516 may be assigned for training for this type of data, e.g., by the training system 510.

Each of the selected Bright pool agent(s) 516 then perform inferencing and produce output(s), e.g., annotations for each datum or for each data set. The output(s) include label(s) or annotations generated based on the input data. The output(s) from each of the selected Bright pool agent(s) 516 are sent to a combiner module 521. The combiner module 521 may correspond to the combiner module 110 of FIG. 1. The combiner module 521 combines (pools) one or more outputs received and performs statistical operations to derive optimal outputs as described above.

The combined output(s), e.g., annotated data, are then sent to a validation module 522 to perform online ground-truthing of the combined output(s). The validation module 522 may be an automated annotation system, or an ML model that can annotate data and provide continuous ground-truthing of the combined output(s) of the Bright pool agent(s) 516. The online ground-truthing by the validation module 522 may correspond to the ground-truthing performed at block 207 of FIG. 2.

The combined output(s) are used to evaluate, by a model evaluation module 523, the performance of each Bright pool agent of the Bright pool agent(s) 516, or in some instances performance of the Bright pool 517 as a whole. This performance evaluation can be partially based on the online ground-truthing of the validation module 522 amongst other evaluation factors and evaluates the performance of the individual agents of the Bright pool agent(s) 516 or of the Bright pool 517 as a whole in producing inferences, e.g., annotating data. The model evaluation module 523 performs model evaluation corresponding to the model evaluation performed at block 210 of FIG. 2. The Bright pool agent(s) 516 can be ranked, and information relating to each agent and its performance related top various types of data can be registered. Poorly performing Bright pool agent(s) can be removed from the Bright pool 517, assigned to training by the training system 510, or sent to the Dark pool 511, e.g., via the data pipeline connector 518. In some aspects, the model evaluation module 523 may correspond to the model evaluation module 520.

The example 500 can also include a lab environment 525, e.g., an enterprise system to receive and process human inputs. In some aspects, the lab environment 525 comprises Bright pool agent(s) 516 that are human. The lab environment 525 can also comprise the SME 504 or onsite systems that receive inputs from the SME 504. The SME 504 performs offline ground-truthing at block 524 for annotated data that the SME receives from the validation module 522. The offline ground-truthing provide master ground-truths for the data that can override any online ground-truthing by the validation module 522, and can override any annotations generated by the Bright pool agent(s) 516.

The offline ground-truthed data is then sent to the data storage 508 to be stored for further passes to train agents, or to be further annotated. Multiple passes of the described processes of the example 500 can be performed on received data from block 505. In some aspects, some portions of the example 500 are repeated while other portions only occur once or for a limited number of times. For example, a certain number of passes of the described processes of the controller 550 can occur without any passes of any other components of the example 500. Alternatively, a certain number of passes of the processes of the training system 510 occur, while another number of passes of the processes of the controller 550 occur. For example, the SME is only available at certain occasions and therefore the offline ground-truthing at block 524 only occurs after a certain number of passes of the controller 550 have occurred. Additionally, a certain number of passes of the training processes in the training system 510 may have to occur for each pass of the inferencing processes of the controller 550.

In some aspects, specific performance parameters must be achieved by the training system 510 to trigger the controller 550 processes, e.g., generating a certain number of performative agents of the Dark pool agent(s) 512. Additionally, receipt of data at 505 may trigger a preset, e.g., set by the data scientist 503, number of passes of processes of each of the data manager module 506, the training system 510, the controller 550, and the lab environment 525.

### Example Method for Inferencing with an EoAs

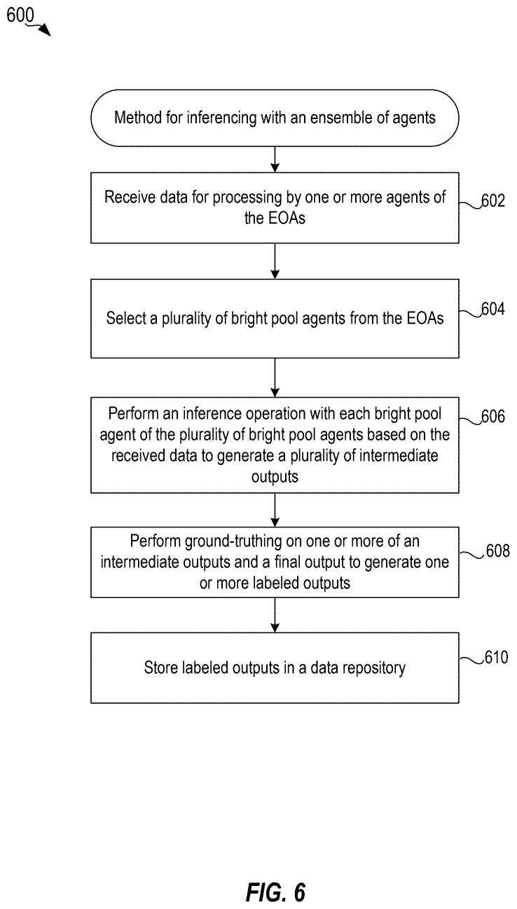

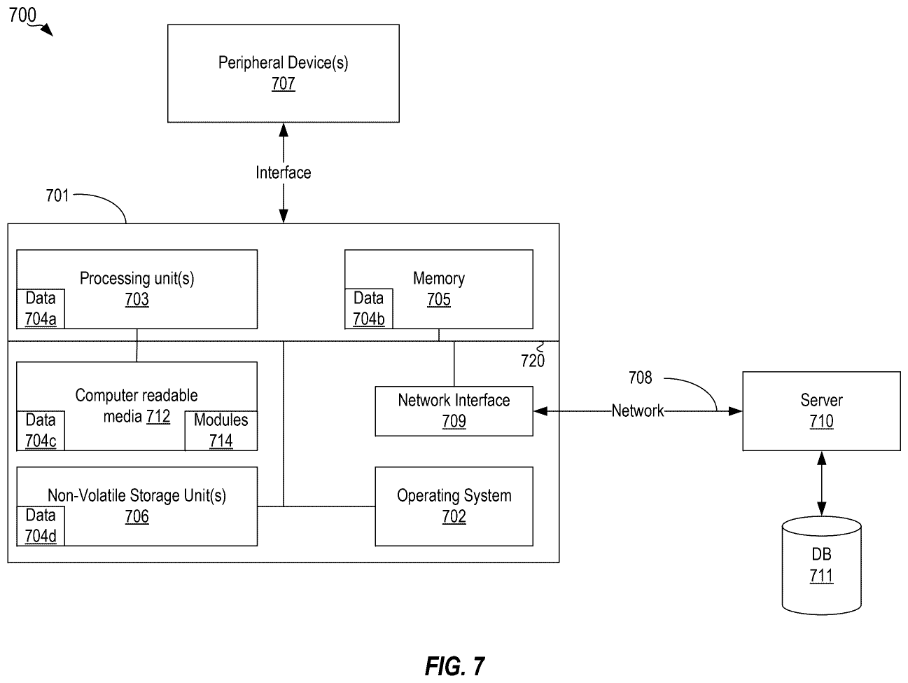

FIG. 6 depicts an example of a method 600 performed by a processing system for inferencing with an EoAs. In one aspect, method 600 may be performed by a processing system, such as example processing system 700 described with reference to FIG. 7.

Method 600 begins at block 602 with receiving data for processing by one or more agents of the ensemble of agents (“EoAs”). In some aspects, block 602 may correspond to ingesting data at blocks 202, 301, or 401 of FIGS. 2-4.

Method 600 then proceeds to block 604 with selecting a plurality of Bright pool agents from the EoAs. In some aspects, block 604 may correspond to selecting agents at the fourth block 404 of FIG. 4.

In some aspects, the selecting of Bright pool agents comprises determining a current load of one or more agents from the EoAs.

In some aspects, the selecting of Bright pool agents comprises determining a historical inference performance of one or more agents from the EoAs.

Method 600 then proceeds to block 606 with performing an inference operation with each Bright pool agent of the plurality of Bright pool agents based on the received data to generate a plurality of intermediate outputs. In some aspects, block 606 may correspond to performing inferences at blocks 208 or 209 of FIG. 2, fifth block 305 of FIG. 3, or sub-block 405a of FIG. 4.

Method 600 then proceeds to block 608 with performing ground-truthing on one or more of an intermediate outputs and a final output to generate one or more labeled output. In some aspects, block 608 may correspond to ground-truthing at block 207 of FIG. 2, block 308 of FIG. 3, or the third sub-block 405c of FIG. 4

Method 600 then proceeds to block 610 with storing the labeled outputs in a data repository. In some aspects, block 610 may correspond to storing data at block 213 of FIG. 2, the tenth block 310 of FIG. 3, or the fourth sub-block 405d of FIG. 4.

In some aspects, the method 600 includes outputting one or more of the intermediate outputs and the final output.

In some aspects, the selecting method 600 includes combining additional data from the data repository with the received data prior to performing the inference operation with each Bright pool agent of the plurality of Bright pool agents.

In some aspects, the method 600 includes evaluating an inference performance of each Bright pool agent of the plurality of Bright pool agents.

In some aspects, the method 600 includes removing at least one of the selected Bright pool agents from the plurality of Bright pool agents based on an inference performance of the at least one of the selected Bright pool agents.

In some aspects, the method 600 includes performing an inference operation with a plurality of Dark pool agents based on the received data to generate a plurality of test outputs.

In some aspects, the method 600 includes evaluating an inference performance of each Bright pool agent of the plurality of Dark pool agents.

In some aspects, the method 600 includes adding at least one Dark pool agent of the plurality of Dark pool agents to the plurality of Bright pool agents based on an inference performance of the at least one Dark pool agent.

In some aspects, the method 600 includes comprising combining the intermediate outputs to generate the final output.

Method 600 provides various benefits including those derived from the usage of an EoAs. Several technical benefits over the art include the deployed solution improving its performance continuously and rapidly as more data is collected. For example, aspects described herein construct the EoAs, monitor the EoAs and its outputs, as well as performance metrics of individual agents and to use their outputs (both individual and combined) to ground-truth and expand the available data set(s), to train new or existing agents and improve their performance metrics further, to prepare the EoAs for deployment, to deploy the EoAs, to enable active, life-long, continuous or federated learning of the agents, and to improve the ensemble performance both in training and in deployment to produce rapid annotations for data for ML available immediately with minimal lag between training and deployment of agents.

### Example Processing System for Training and Inferencing for Rapid Annotation for ML

FIG. 7 depicts an example processing system 700 configured to perform various aspects described herein, including, for example, method 600 as described above with respect to FIG. 6.

The host device 701 as represented herein may refer to one or more host devices. In some aspects, the host device 701 operates as a standalone device or may be connected (e.g., networked) to other machines or devices. In a networked deployment, the host device 701 may operate in the capacity of a server or a client device in a server-client network environment, as a peer device in a peer-to-peer (or distributed) network environment, or a node in a network environment. Examples of the host device 701 can include and are not limited to a computer or computing device, a personal computer (“PC”), a smart device (that can include a phone, tablet computer, watch, virtual or augmented reality headset, or audio device), an internet-of-things (“IOT”) device, a set-top box (“STB”), a personal digital assistant (“PDA”), a cellular telephone, a portable music player (e.g., a portable hard drive audio device such as an Moving Picture Experts Group Audio Layer 3 (“MP3”) player), a web appliance, a network router, switch or bridge, or any machine capable of executing a set of instructions (sequential or otherwise) that specify actions to be taken by that machine or device. Further, while only a single machine or device is illustrated, the terms “machine” and “device” shall also be taken to include any collection of machines or devices that individually or jointly execute a set (or multiple sets) of instructions to perform any one or more of the methods described herein.

The example processing system 700 includes the host device 701 running a host operating system (“OS”) 702 via processing unit(s) 703 that may include a single or multiple processor/processor cores (e.g., a central processing unit (“CPU”), a graphics processing unit (“GPU”), or both). Processing unit(s) 703 may also retrieve, receive, or execute instructions or information (“data”), e.g., data 704b from memory 705.

The host device 701 can include non-volatile storage unit(s) 706, for example, a disk drive unit including one that may be a Solid-state Drive (“SSD”), a hard disk drive (“HDD”), embedded MultiMediaCard (“e.MMC”), and Universal Flash Storage (“UFS”), or other computer or machine-readable medium on which is stored one or more sets of instructions and data structures (e.g., the data 704d) embodying or utilizing any one or more of the methodologies or functions described herein. The data 704a-704d may also reside, completely or at least partially, within a memory 705 and/or within the processing unit(s) 703 during execution thereof by the host device 701. The processing unit(s) 703, and the memory 705 may also comprise machine-readable media.

All the various components shown in host device 701 may be connected with and to each other, or communicate to one another via a bus 720 or via other coupling or communication channels or mechanisms. The host device 701 include or be coupled to one or more peripheral device(s) 707. Non-limiting examples of peripheral device(s) 707 can include a video display, an audio device, alphanumeric or other input device(s) (e.g., a keyboard, a cursor control device, a mouse, or a voice recognition or biometric verification unit), a connection or expansion hub, a signal generation device (e.g., a speaker,) or an external persistent storage device (such as an external disk drive unit). The host device 701 may further include data encryption module(s) (not shown) to encrypt data, such as the data 704a-704d.

The components provided in the host device 701 are those typically found in computer systems that may be suitable for use with aspects of the present disclosure and are intended to represent a broad category of such computer components that are known in the art. Thus, the example processing system 700 can be a server, minicomputer, mainframe computer, or any other computing system. The computer may also include different bus configurations, networked platforms, multi-processor platforms, and the like. Various operating systems may be used by each of the various components of the example processing system 700 including UNIX™, LINUX™, WINDOWS™, QNX™ ANDROID™, IOS™, CHROME™, TIZEN™, and other suitable operating systems. The aforementioned operating systems may or may not correspond with OS 702.

The data 704a-704d may further be communicated over a network 708 via a network interface 709 utilizing one or more well-known communication or transfer protocols (e.g., Hyper Text Transfer Protocol (“HTTP”)). The example processing system 700 may also include a server 710. The server 710 as represented herein may refer to one or more servers. The host device 701 can therefore communicate via the network 708 to the server 710 or to other nodes, endpoints, or servers that are not part of the example processing system 700. The server 710 may be a database server, or may implement database solutions and/or may be connected to a database (“DB”) 711 or other storage system or repository configured to store data and allow for data management and retrieval by the server 710. The DB 711 as represented herein may refer to one or more databases. The DB 711 may be used to store data from the host device 701 or the server 710, including storing enterprise or organizational data, including user data, internal and third party application data, and data collected from on-premises or cloud activity.

The host device 701 may also include computer readable media 712, able to store the data 704a-704d and able to store the various modules 714 that can undertake the various processes described herein. The modules 714 may include and are not limited to a receiving module, a selecting module, a performing module, a storing module, a combining module, an evaluating module, a removing module, an adding module, a data stewardship module, a controller module, a data manager module, a training system module, a dispatcher module, a an IEC module, a data ingestion module, a data stratification module, a data augmentation module, a data annotation module, a ground-truthing module, model evaluation module, a validation module, a model performance module, a training model evaluation module, and a training module that can undertake any of the processes described herein including those aspects in FIGS. 1-6.

The term “computer-readable medium/media” or “machine-readable medium/media” as used herein may refer to a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions or data structures, e.g., the data 704a-704d, for execution by any device, including and not limited to the host device 701 and which causes such devices to perform any one or more of the methodologies of the present application. Such media may also include, without limitation, all types of memory and storages, hard disks, floppy disks, flash memory cards, digital video disks, random access memory (“RAM”), read only memory (“ROM”), and the like. The example aspects described herein may be implemented in an operating environment comprising software installed on a computer, in hardware, or in a combination of software and hardware.

One skilled in the art will recognize that internet service may be configured to provide internet access to one or more host devices that are coupled to the internet service. Furthermore, those skilled in the art may appreciate that the internet service may be coupled to one or more databases, repositories, servers, host devices and the like, which may be utilized to implement any of the aspects of the disclosure as described herein.

The computer program instructions, that may include for example the data 704a-704d, may be loaded onto a computer, a server, other programmable data processing apparatus, or other devices to cause a series of operational steps to be performed on the computer, server, or the other programmable data processing apparatus or other devices to produce a computer implemented process such that the instructions which execute on the computer or other programmable apparatus provide processes for implementing the functions/acts specified in presented flowchart(s) or block diagram block(s) of FIG. 6.

A network or networks as described herein, such as the network 708, may include or interface with, as non-limiting examples, any one or more of, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SON ET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CODI (Copper Distributed Data Interface) connection. Furthermore, communications may also include links to any of a variety of wireless networks, including WAP (Wireless Application Protocol), GPRS (General packet Radio Service), GSM (Global System for Mobile Communication), CDMA (Code Division Multiple Access) or TOMA (Time Division Multiple Access), cellular phone networks, GPS (Global Positioning System), CDPD (cellular digital packet data), RIM (Research in Motion, Limited) duplex paging network,

Bluetooth radio, or an IEEE 802.11-based radio frequency network. The network 1208 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers, which can include the server 710. This network of web servers can therefore comprise a plurality of computing devices, such as the host device 701, with the web servers, such as the server 710 providing processor and/or storage resources. These web servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, e.g., the host device 1201, as a standalone software package, partly on the user's computer and partly on a remote computer or entirely on the remote computer or the server 1210. In the latter scenario, the remote computer may be connected to the user's computer through any type of network as described herein or as known in the art.

### Example Clauses

Implementation examples are described in the following numbered clauses:

Clause 1: A method for inferencing with an ensemble of agents, comprising receiving data for processing by one or more agents of the ensemble of agents (EoAs); selecting a plurality of Bright pool agents from the EoAs; performing a first inference operation with each Bright pool agent of plurality of Bright pool agents based on the received data to generate a plurality of intermediate outputs; performing ground-truthing on one or more of an intermediate outputs and a final output to generate one or more labeled outputs; and storing the labeled outputs in a data repository.

Clause 2: The method of Clause 1, further comprising outputting one or more of the intermediate outputs and the final output.

Clause 3: The method of any of Clauses 1-2, wherein selecting the plurality of Bright pool agents from the ensemble of agents comprises determining a current load of one or more agents from the EoAs.

Clause 4: The method of claim any of Clauses 1-3, wherein selecting the plurality of Bright pool agents from the EoAs comprises determining a historical inference performance of one or more agents from the EoAs.

Clause 5: The method of any of Clauses 1-4, further comprising combining additional data from the data repository with the received data prior to performing the first inference operation with each Bright pool agent of the plurality of Bright pool agents.

Clause 6: The method of any of Clauses 1-5, further comprising evaluating an inference performance of each Bright pool agent of the plurality of Bright pool agents; and removing at least one Bright pool agent from the plurality of Bright pool agents based on an inference performance of the at least one agent.

Clause 7: The method of any of Clauses 1-6, further comprising performing a second inference operation with a plurality of Dark pool agents based on the received data to generate a plurality of test outputs; evaluating an inference performance of each Dark pool agent of the plurality of Dark pool agents; and adding at least one Dark pool agent of the plurality of Dark pool agents to the plurality of Bright pool agents based on the inference performance of the at least one Dark pool agent.

Clause 8: The method of any of Clauses 1-7, further comprising combining the intermediate outputs to generate the final output.

Clause 9: The method of any of Clauses 1-8, wherein the EoAs comprise a plurality of Bright pool agents and a plurality of Dark pool agents.

Clause 10: One or more processing systems, comprising: one or more memories comprising computer-executable instructions; and one or more processors configured to execute the computer-executable instructions and cause the one or more processing systems to perform a method in accordance with any one of Clauses 1-9.

Clause 11: One or more processing systems, comprising means for performing a method in accordance with any one of Clauses 1-9.

Clause 12: One or more non-transitory computer-readable media comprising instructions that, when executed by one or more processors of a computing system, cause the computing system to perform the operations of any one of Clauses 1-9.

Clause 13: One or more computer program products embodied on one or more computer-readable storage media comprising code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, acc, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, unless stated otherwise, the term “or” is used in an inclusive sense. This inclusive usage of or is equivalent to “and/or”. Thus, when options are delineated using “or,” it permits the selection of one or more of the enumerated options concurrently. For example, if the document stipulates that a component may comprise option A or option B, it shall be understood to mean that the component may comprise option A, option B, or both option A and option B, and does not mean, unless stated expressly that the component includes either option A or option B. This inclusive interpretation ensures that all potential combinations of the options are permissible, rather than restricting the choice to a singular, exclusive option.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for inferencing with an ensemble of agents (EoAs), comprising:
receiving data for processing by one or more agents of the EoAs;
selecting a plurality of Bright pool agents from the EoAs;
performing a first inference operation with each Bright pool agent of the plurality of Bright pool agents based on the received data to generate a plurality of intermediate outputs;
performing ground-truthing on one or more of an intermediate outputs and a final output to generate one or more labeled outputs; and
storing the labeled outputs in a data repository.

2. The method of claim 1, further comprising outputting one or more of the intermediate outputs and the final output.

3. The method of claim 1, wherein selecting the plurality of Bright pool agents from the EoAs comprises determining a current load of one or more agents from the EoAs.

4. The method of claim 1, wherein selecting the plurality of Bright pool agents from the EoAs comprises determining a historical inference performance of one or more agents from the EoAs.

5. The method of claim 1, further comprising combining additional data from the data repository with the received data prior to performing the first inference operation with each Bright pool agent of the plurality of Bright pool agents.

6. The method of claim 1, further comprising:
evaluating an inference performance of each Bright pool agent of the plurality of Bright pool agents; and
removing at least one Bright pool agent from the plurality of Bright pool agents based on the inference performance of the at least one Bright pool agent.

7. The method of claim 1, further comprising:
performing a second inference operation with a plurality of Dark pool agents based on the received data to generate a plurality of test outputs;
evaluating an inference performance of each Dark pool agent of the plurality of Dark pool agents; and
adding at least one Dark pool agent of the plurality of Dark pool agents to the plurality of Bright pool agents based on the inference performance of the at least one Dark pool agent.

8. The method of claim 1, further comprising combining the intermediate outputs to generate the final output.

9. A system for inferencing with an ensemble of agents (EoAs), comprising a processing system that includes one or more processors and one or more memories coupled with the one or more processors, the processing system configured to cause the system to:
receive data for processing by one or more agents of the EoAs;
select a plurality of Bright pool agents from the EoAs;
perform a first inference operation with each Bright pool agent of the plurality of Bright pool agents based on the received data to generate a plurality of intermediate outputs;
perform ground-truthing on one or more of an intermediate outputs and a final output to generate one or more labeled outputs; and
store the labeled outputs in a data repository.

10. The system of claim 9, wherein the processing system is further configured to output one or more of the intermediate outputs and the final output.

11. The system of claim 9, wherein to select the plurality of Bright pool agents from the EoAs, the processing system is further configured to determine a current load of one or more agents from the EoAs.

12. The system of claim 9, wherein to select the plurality of Bright pool agents from the EoAs, the processing system is further configured to determine a historical inference performance of one or more agents from the EoAs.

13. The system of claim 9, wherein the processing system is further configured to combine additional data from the data repository with the received data prior to performing the first inference operation with each Bright pool agent of the plurality of Bright pool agents.

14. The system of claim 9, wherein the processing system is further configured to:
evaluate an inference performance of each Bright pool agent of the plurality of Bright pool agents; and
remove at least one Bright pool agent from the plurality of Bright pool agents based on the inference performance of the at least one Bright pool agent.

15. The system of claim 9, wherein the processing system is further configured to:
perform a second inference operation with a plurality of Dark pool agents based on the received data to generate a plurality of test outputs;
evaluate an inference performance of each Dark pool agent of the plurality of Dark pool agents; and
add at least one Dark pool agent of the plurality of Dark pool agents to the plurality of Bright pool agents based on the inference performance of the at least one Dark pool agent.

16. The system of claim 9, wherein the processing system is further configured to combine the intermediate outputs to generate the final output.

17. The system of claim 9, wherein the EoAs comprise the plurality of Bright pool agents and a plurality of Dark pool agents.

18. One or more non-transitory computer-readable media comprising executable instructions that, when executed by one or more processors, perform operations comprising:
receiving data for processing by one or more agents of an ensemble of agents (EoAs);
selecting a plurality of Bright pool agents from the EoAs;
performing a first inference operation with each Bright pool agent of the plurality of Bright pool agents based on the received data to generate a plurality of intermediate outputs;
performing ground-truthing on one or more of an intermediate outputs and a final output to generate one or more labeled outputs; and
storing the labeled outputs in a data repository.

19. The one or more non-transitory computer-readable media of claim 18, wherein the executable instructions when executed by one or more processors, further perform operations comprising:
evaluating an inference performance of each Bright pool agent of the plurality of Bright pool agents; and
removing at least one Bright pool agent from the plurality of Bright pool agents based on the inference performance of the at least one Bright pool agent.

20. The one or more non-transitory computer-readable media of claim 18, wherein the executable instructions when executed by one or more processors, further perform operations comprising:
performing a second inference operation with a plurality of Dark pool agents based on the received data to generate a plurality of test outputs;
evaluating an inference performance of each Dark pool agent of the plurality of Dark pool agents; and
adding at least one Dark pool agent of the plurality of Dark pool agents to the plurality of Bright pool agents based on the inference performance of the at least one Dark pool agent.
